(19) United States
(12) Patent Application Publication
(10) Pub. No.: US 2026/0088488 A1
(43) Pub. Date: Mar. 26, 2026

(54) Base Station Antenna for Lowering Wind Loads

(71) Applicant: OUTDOOR WIRELESS NETWORKS LLC, Richardson, TX (US)

(72) Inventors: Maosheng Liu, Suzhou (CN); PuLiang Tang, Suzhou (CN)

(21) Appl. No.: 19/311,773

(22) Filed: Aug. 27, 2025

(30) Foreign Application Priority Data
Sep. 20, 2024 (CN) 202411314208.0

(51) Int. Cl. H01Q 1/24; H01Q 1/42

(52) U.S. Cl. CPC H01Q 1/246; H01Q 1/42

(57) ABSTRACT

The present invention relates to a base station antenna for lowering wind loads, the base station antenna comprising: an antenna housing having a front surface, a rear surface, a first side surface, and a second side surface; a top end cover and a bottom end cover, the top end cover and bottom end cover being arranged at an upper end and a lower end of the antenna housing to define an interior cavity; and a radiating element located within the interior cavity and configured to transmit and receive radio frequency signals, wherein the front surface has a recessed profile feature in an intermediate section, and the rear surface has a rib profile feature in an intermediate section.

### RELATED APPLICATION

The present application claims priority from and the benefit of Chinese Patent Application No. 202411314208.0, filed Sep. 20, 2024, the disclosure of which is hereby incorporated herein by reference in full.

### FIELD OF THE INVENTION

The present application generally relates to the technical field of antennas, and more particularly relates to a base station antenna for lowering wind loads.

### BACKGROUND OF THE INVENTION

As the development of the wireless communication industry, the communication frequency band and form continue to grow, and the number of base station antennas that serve as transmitting antennas and receive wireless signals continue to grow. In addition, to accommodate more radio frequency elements, the sizes of antenna housings are increasing, and wind loads of antennas are accordingly increasing, thereby affecting the security of communication towers.

One parameter that affects the antenna design is the effective projected area (EPA) which is determined by calculation defined by TIA/ANSI-222-H. The effective projected area aims to predict effects of wind loads on antennas and their mounting structures, enabling designers to be capable of creating a secure design. Antenna housings are key structures to protect antenna systems from external environmental influences, and they play an important role in the effective projected area of base station antennas. Therefore, based on the market demand on the wind loads of antennas, there is an urgent need for a base station antenna for lowering wind loads.

### SUMMARY OF THE INVENTION

Therefore, an objective of the present application is to provide a base station antenna for lowering wind loads that is capable of overcoming at least one drawback in the prior art.

According to a first aspect of the present application, a base station antenna for lowering wind loads is provided, the base station antenna comprising: an antenna housing having a front surface, a rear surface, a first side surface, and a second side surface; a top end cover and a bottom end cover, the top end cover and bottom end cover being arranged at an upper end and a lower end of the antenna housing to define an interior cavity; and a radiating element located within the interior cavity and configured to transmit and receive radio frequency signals, wherein the front surface has a recessed profile feature in an intermediate section, and the rear surface has a rib profile feature in an intermediate section.

According to a second aspect of the present application, a base station antenna for lowering wind loads is provided, the base station antenna comprising: an antenna housing having a front surface, a rear surface, a first side surface, and a second side surface; a top end cover and a bottom end cover, the top end cover and the bottom end cover being arranged at an upper end and a lower end of the antenna housing to define an interior cavity; and a radiating element located within the interior cavity and configured to transmit and receive radio frequency signals, wherein a dog bone type cross-sectional profile is formed by the front surface, the 2 rear surface, the first side surface, and the second side surface of the antenna housing, and the dog bone type cross-sectional profile comprises: a first circular arc section transiting to the first side surface from an intermediate section of the front surface in a forward protruding manner, and a second circular arc section transiting to the second side surface from the intermediate section of the front surface in a forward protruding manner; and a third circular arc section transiting to the first side surface from an intermediate section of the rear surface in a rearward protruding manner, and a fourth circular arc section transiting to the second side surface from the intermediate section of the rear surface in a rearward protruding manner.

According to a third aspect of the present application, a base station antenna for lowering wind loads is provided, the base station antenna comprising: an antenna housing having a front surface, a rear surface, a first side surface, and a second side surface; a top end cover and a bottom end cover, the top end cover and the bottom end cover being arranged at an upper end and a lower end of the antenna housing to define an interior cavity; a radiating element located within the interior cavity and configured to transmit and receive radio frequency signals; and a mounting assembly, the mounting assembly comprising a plate member for being mounted on the rear surface of the antenna housing; a bracket assembly extending rearward from the plate member and used for securing a holding pole; and a bracket cover for covering the plate member and the bracket assembly externally, the bracket cover having a rounded and smooth profile.

### DESCRIPTION OF ATTACHED DRAWINGS

The present application is further detailed with reference to the attached drawings and specific embodiments. Brief descriptions of the illustrative drawings are provided as follows:

FIG. 1 is a front perspective view of a known base station antenna;

FIG. 2 is a top view of another known base station antenna;

FIG. 3 is a schematic diagram of different wind load directions on a base station antenna;

FIG. 4 to FIG. 6 are schematic views of a base station antenna according to a first embodiment of the present application, illustrating top views and a side perspective view of the base station antenna, respectively;

FIG. 7 to FIG. 11 are some schematic views of a base station antenna according to a second embodiment of the present application, illustrating top views, a side perspective view and a cross-sectional view of the base station antenna, respectively;

FIGS. 12A-12E illustrate schematic diagrams of base station antennas according to additional embodiments of the present application;

FIG. 13 to FIG. 14 are partial views of an antenna housing of a base station antenna according to embodiments of the present application, illustrating a recessed profile feature on a front surface of the antenna housing;

FIG. 15 to FIG. 18 are top, perspective and partial perspective views of a base station antenna according to embodiments of the present application, illustrating a rib profile feature on a rear surface of the antenna housing;

FIG. 19 is an omni-directional wind load distribution feature diagram of a base station antenna according to some examples of the present application, illustrating advantageous effects of the recessed profile feature and the rib profile feature on lowering lateral wind loads;

FIG. 20 to FIG. 23 are perspective and partial perspective views of a base station antenna according to embodiments of the present application, and a bracket cover is provided for a bracket assembly of the base station antenna.

### SPECIFIC EMBODIMENTS

The present application will be described below with reference to the attached drawings, wherein the attached drawings illustrate certain examples of the present application. However, it should be understood that the present application may be presented in many different ways and is not limited to the examples described below; in fact, the examples described below are intended to make the disclosure of the present application more complete and to fully explain the protection scope of the present application to those skilled in the art. It should also be understood that the examples disclosed in the present disclosure may be combined in various ways so as to provide more additional examples.

In various examples of different descriptions, same reference numerals or same element names are configured for same elements, wherein the disclosures contained in the full text of the Specification can be transferred to elements having same reference numerals or same element names as intended. Further, in various examples, the number of elements, implementations, and/or arrangement structures are not limited to the illustrated examples, but are capable of selecting other quantities, implementations, and/or arrangement structures according to actual needs.

As used herein, spatial relational terms such as “above,” “below,” “left,” “right,” “front,” “back,” “high,” “low,” and the like are used to describe the relationship of one feature to another feature in the attached drawings. It should be understood that spatial relational terms, in addition to the orientations shown in the attached drawings, also encompass different orientations of the apparatus during use or operation. For example, when the apparatus is flipped in the attached drawings, a feature previously described as “below” another feature may now be described as “above” that other feature. The apparatus may also be oriented in other ways (rotated 90 degrees or in other orientations), and the relative spatial relationships will be interpreted accordingly in those cases.

As used herein, the term “A or B” comprises “A and B” and “A or B”, not exclusively “A” or “B”, unless otherwise specified.

As used herein, the terms “illustrative” or “exemplary” mean “serving as an example, instance, or illustration,” rather than as a “model” to be precisely replicated. Any realization method described exemplarily herein is not necessarily interpreted as being preferable or advantageous over other realization methods. Furthermore, the present application is not limited by any expressed or implied theory given in the above technical field, background art, summary of the invention or embodiments.

As used herein, the term “substantially” means encompassing slight variations resulting from design or manufacturing defects, tolerances of components or elements, environmental influences, and/or other factors.

As used herein, the term “part” may be a part of any proportion. For example, it may be larger than 10%, 20%, 30%, 40%, 50%, 60%, 70%, 80%, 90%.

In addition, for reference purposes only, “first”, “second” and similar terms may also be used herein, and thus are not intended to be limitative. For example, unless the context clearly indicates, the words “first”, “second” and other such numerical words involving structures or elements do not imply a sequence or order.

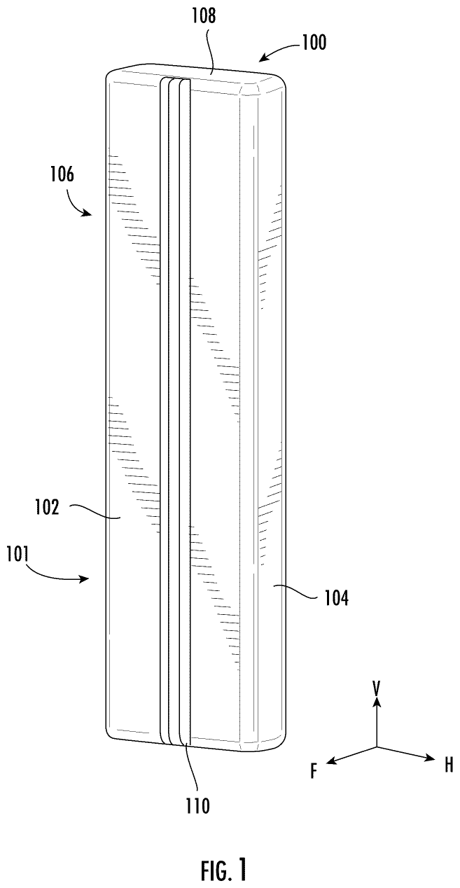

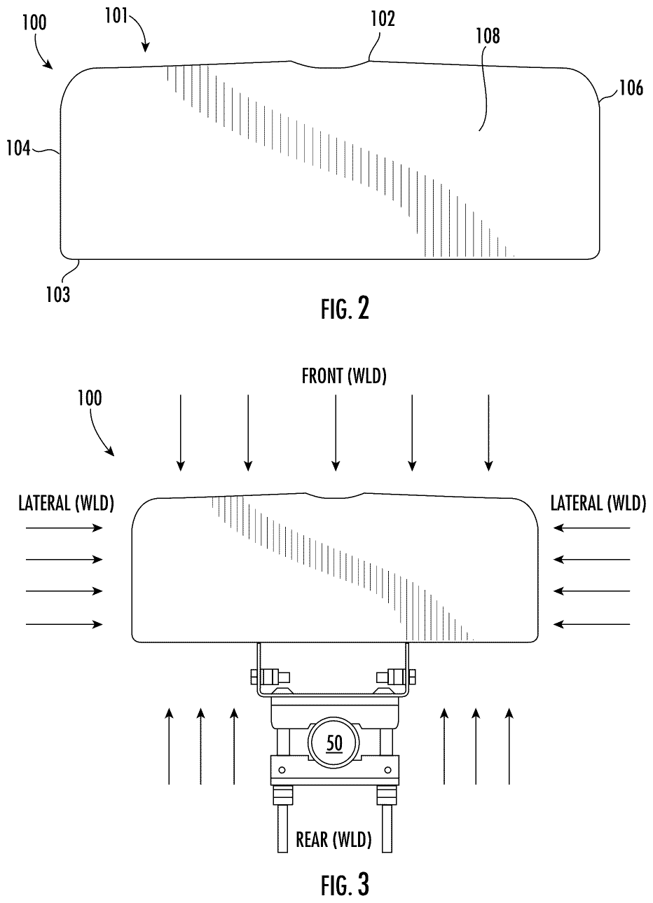

Referring to FIG. 1 to FIG. 2, a known base station antenna 100 is shown, the base station antenna 100 is generally mounted in a vertical mode (i.e., when the base station antenna 100 is in normal operation, a longitudinal direction or vertical direction V may be generally perpendicular to a plane defined by a horizon line). The longitudinal direction V of the base station antenna 100 may be perpendicular to a horizontal direction H and a forward direction F, and a radiating element array mounted within the base station antenna may extend forward along the forward direction F from a reflector.

The base station antenna 100 is generally elongated is covered by an antenna housing 101 comprising a front surface 102, a rear surface 103, a first side surface 104, and a second side surface 106, and is also covered by a top end cover 108 and a bottom end cover 110. In some instances, the antenna housing 101 and the end covers 108, 110 may comprise single unitary components; while in other examples, the antenna housing 101 and the end covers 108, 110 may comprise separate parts, and the end covers 108, 110 may be mounted on the antenna housing 101.

An interior cavity is defined by the antenna housing and the end covers, an internal antenna component (for example, a radiating element, a reflector, a phase mover, a duplexer, a remote electronic tilt actuator, a cable, a controller, etc.) that enables the base station antenna 100 to be capable of transmitting and receiving radio frequency (RF) signals may be contained in the interior cavity. Exemplary antenna components are described, for example, in PCT Publication No. WO2017/165512A1, the disclosure of which is incorporated herein by reference. The base station antenna 100 also comprises a connector (not shown in the figures); the connector enables the base station antenna 100 to be capable of connecting with one or more radio devices for transmitting and receiving RF signals, as well as connecting with other associated telecommunication devices.

The base station antenna 100 is generally mounted well above the ground for optimizing transmission. Thus, the base station antenna 100 has a significant contribution to overall wind loads on a cellular tower. For example, as shown in FIG. 3, the base station antenna 100 may experience high wind loads from any direction (i.e., front, rear, and/or lateral wind load directions WLDs). Accordingly, design features of the base station antenna 100, and in particular, design features of the antenna housing 101 and the end covers 108, 110 may affect the overall wind loads experienced by the base station antenna 100. It can be critical to lower the wind loads on the base station antenna 100. Moreover, it can be important to manage the wind loads at all different wind attack angles on the base station antenna 100. That is, it is worth pursuing the realization of an optimized omni-directional wind load distribution on the base station antenna 100. According to embodiments of the present invention, several antenna housing profile features that may assist in managing the optimized omni-directional wind load distribution on the base station antenna are provided. It will be understood that various profile features presented in different examples may be flexibly combined and adjusted as needed, and not limited to the specific examples described below.

Some embodiments of the present invention are now described in more detail with reference to the attached drawings.

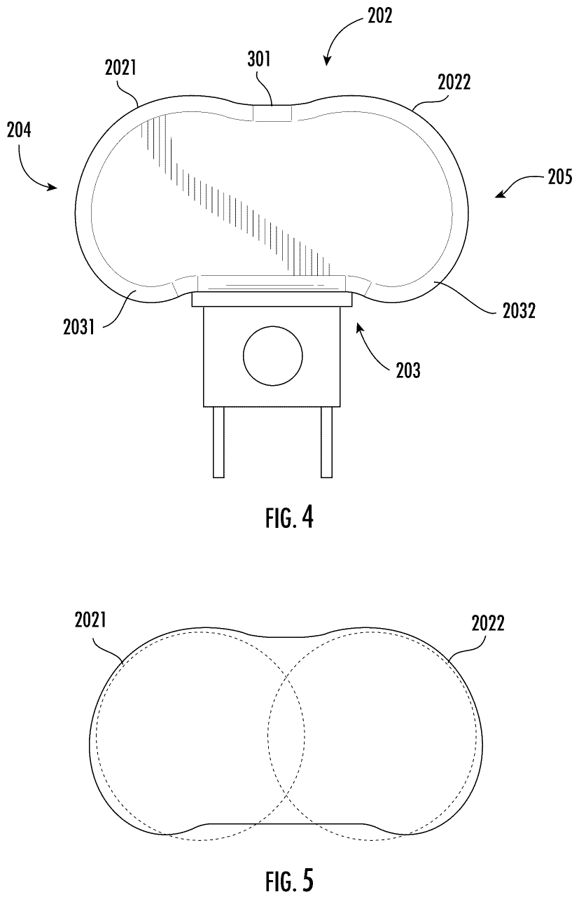

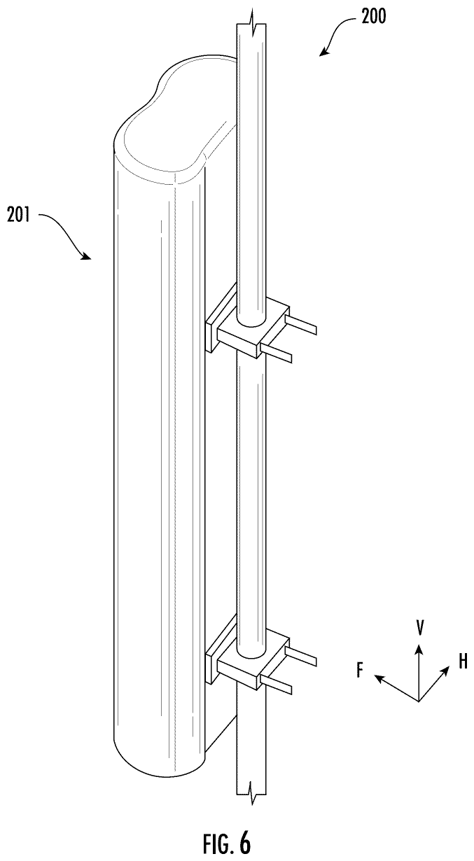

Referring to FIG. 4 to FIG. 6, a base station antenna 200 for lowering wind loads according to a first example of the present application is shown, and an antenna housing 201 of the base station antenna 200 may have a dog bone-type cross-sectional profile. That is, the dog bone-type cross-sectional profile is formed by a front surface 202, a rear surface 203, a first side surface 204, and a second side surface 205 of the antenna housing 201, and the dog-bone type cross-sectional profile may comprise: a first circular arc section 2021 transiting to the first side surface 204 from an intermediate section of the front surface 202 in a forward protruding manner; a second circular arc section 2022 transiting to the second side surface 205 from the intermediate section of the front surface 202 in a forward protruding manner; a third circular arc section 2031 transiting to the first side surface 204 from an intermediate section of the rear surface 203 in a rearward protruding manner; and a fourth circular arc section 2032 transiting to the second side surface 205 from the intermediate section of the rear surface 203 in a rearward protruding manner. It will be understood that, as used herein, each circular arc section may correspond to a circular trajectory having a particular radius of curvature.

Four circular arc corners protruding outward may be formed by the first and second circular arc sections 2021, 2022 protruding forward, and by the third and fourth circular arc sections 2031, 2032 protruding rearward, which may effectively lower front wind loads and rear wind loads experienced by the base station antenna 200.

As shown in FIG. 5, in a further improved example, the first circular arc section 2021 and the first side surface 204 may form a consistent circular arc section, and the consistent circular arc section may extend until the third circular arc section 2031. The second circular arc section 2022 and the second side surface 205 may form a continuous circular arc section, and the continuous circular arc section may extend until the fourth circular arc section 2032. Thus, a consistent long circular arc section may be formed on the front surface 202 as well as the first and the second side surface 205 of the base station antenna 200, respectively, which may correspond to a longer circular trajectory having a particular radius of curvature, respectively, such that the dog bone-type cross-sectional profile is closer to a partial trajectory of two intersecting circles. The dog bone type cross-sectional profile of the first example of the present application may thus obtain the optimized omni-directional wind load distribution.

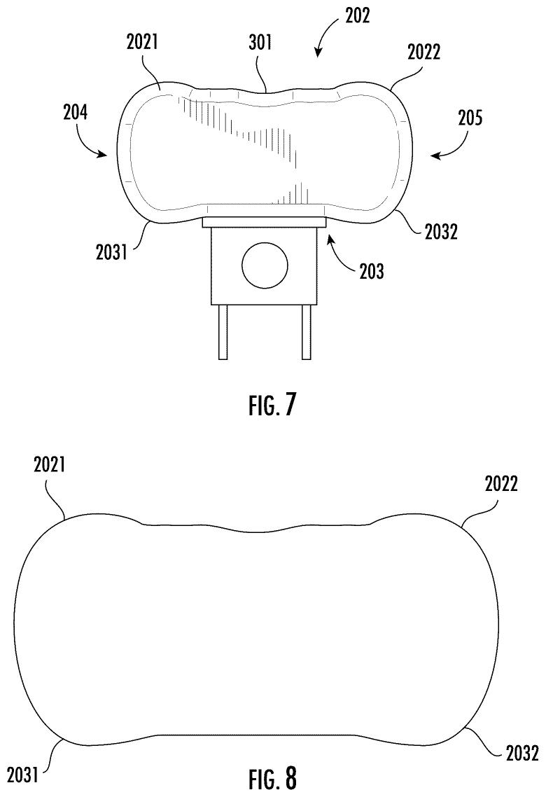

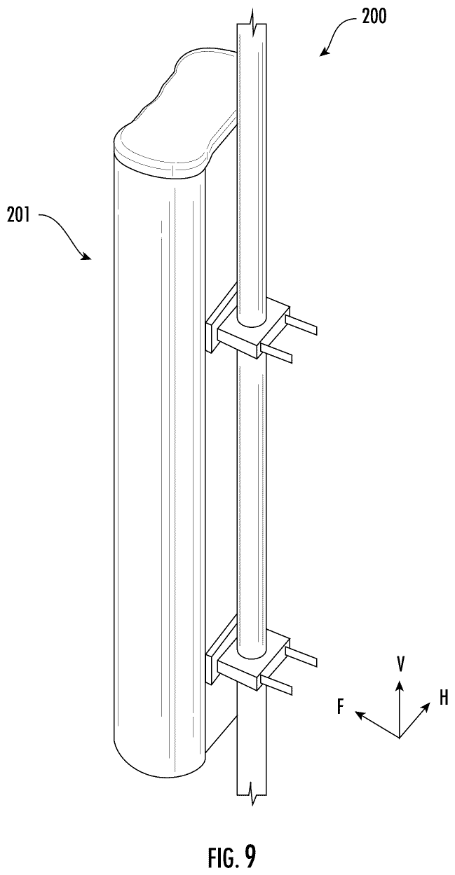

Referring to FIG. 7 to FIG. 10, the base station antenna 200 for lowering wind loads according to a second example of the present application is shown, an antenna housing 201 of the base station antenna 200 may have a dog bone-type cross-sectional profile, and the dog bone-type cross-sectional profile may comprise: a first circular arc section 2021 transiting to the first side surface 204 from an intermediate section of the front surface 202 in a forward protruding manner; a second circular arc section 2022 transiting to the second side surface 205 from the intermediate section of the front surface 202 in a forward protruding manner; a third circular arc section 2031 transiting to the first side surface 204 from an intermediate section of the rear surface 203 in a rearward protruding manner; and a fourth circular arc section 2032 transiting to the second side surface 205 from the intermediate section of the rear surface 203 in a rearward protruding manner. Four circular arc corners protruding outward may be formed by the first and second circular arc sections 2021, 2022 protruding forward, and by the third and fourth circular arc sections 2031, 2032 protruding rearward, which may effectively lower front wind loads and rear wind loads experienced by the base station antenna 200.

Compared to the consistent long circular arc section in the first example, a short circular arc section may be formed by the first and second circular arc sections 2021, 2022 protruding forward in the second example, and an intermediate section of the front surface 202 may be relatively longer and flat. Further, the first and second circular arc sections 2021, 2022 no longer form a consistent circular arc section with the side surfaces 204, 205, i.e., the first and second circular arc sections 2021, 2022 and the side surfaces 204, 205 may correspond to circles having different radii of curvature, respectively. This allows for flexible profile fine tuning to free up more available interior cavity space.

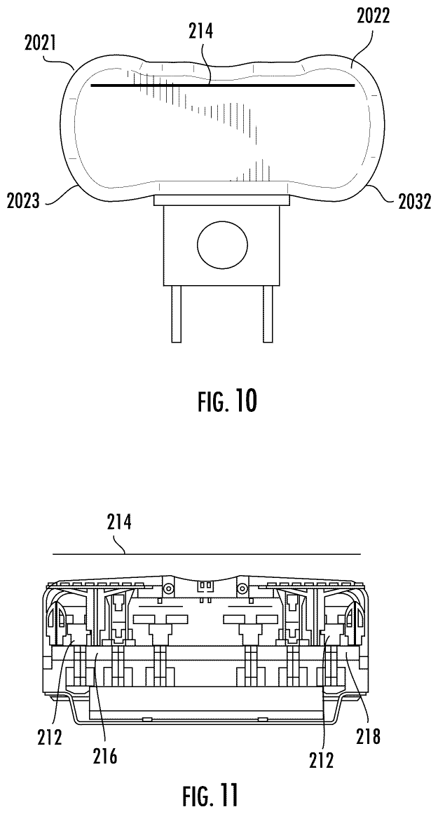

The base station antenna 200 according to the second example of the present application has a favorable interior cavity spatial utilization. As shown in FIG. 10 and FIG. 11, the base station antenna 200 may comprise a frequency selection surface 214 mounted in front of the radiating element 212, the frequency selection surface 214 may extend from a position next to the first circular arc section 2021 in a horizontal direction H until a position next to the second circular arc section 2022. As such, the frequency selection surface 214 may substantially cover the rear radiating element 212 in front so as to, for example, adjust a direction diagram of radiation emitted by the radiating element 212 or, in other words, a radiating element 212 array. In some examples, the base station antenna 200 may comprise a first internal antenna component 216 and a second internal antenna component 218, wherein the first internal antenna component 216 extends from a position next to the rear third circular arc section 2031 forward, i.e. toward the first circular arc section 2021, and the second internal antenna component 218 extends from a position next to the rear fourth circular arc section 2032 forward, i.e. toward the second circular arc section 2022, wherein the first internal antenna component 216 and the second internal antenna component 218 comprise at least one radiating element 212 and a feed assembly for feeding the at least one radiating element 212, respectively, etc.

In some additional examples, the first and second circular arc sections 2021, 2022 which protrude forward and the third and fourth circular arc sections 2031, 2032 which protrude rearward may form four substantially symmetrical circular arc corners, which may thereby effectively lower the front wind loads and the rear wind loads experienced by the base station antenna 200, and achieve more balanced wind load distribution.

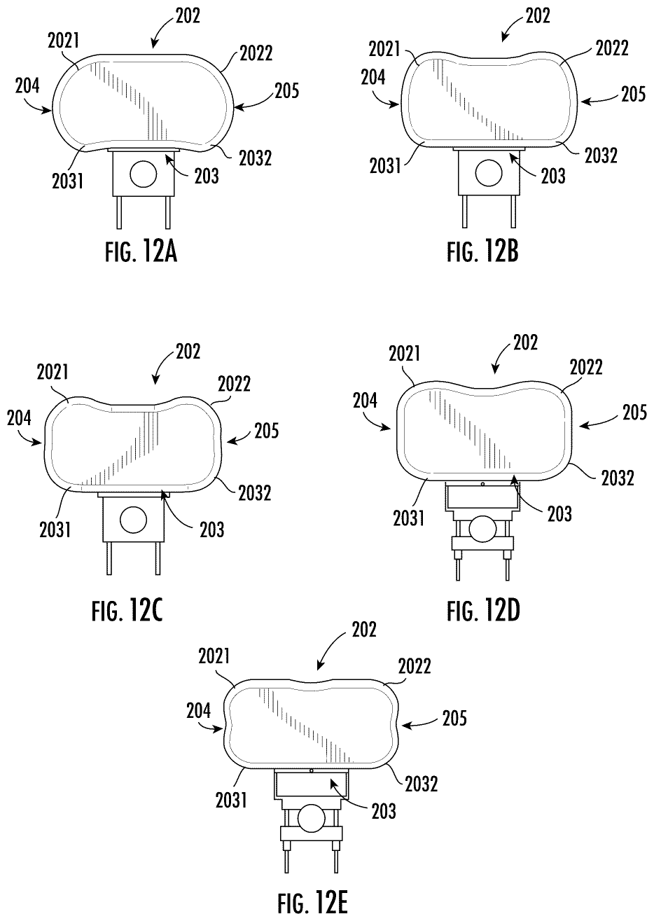

Referring to FIG. 12, a base station antenna 200 according to some other examples of the present application is shown. In these examples, a cross-sectional profile of an antenna housing 201 of the base station antenna 200 may have a design form that is distinct from the first example and the second example.

As shown in a of FIG. 12, the first and second circular arc sections 2021, 2022 transiting from the intermediate section of the front surface 202 to the first and second side surfaces 205 no longer protrude forward. As shown in b, c, and d of FIG. 12, the third and fourth circular arc sections 2031, 2032 transiting from the intermediate section of the rear surface 203 to the third and fourth side surfaces no longer protrude rearward. As shown in e of FIG. 12, not only are the first and second circular arc sections 2021, 2022 no longer protrude forward, but the third and fourth circular arc sections 2031, 2032 no longer protrude rearward. Further, as shown in a and b of FIG. 12, the first and second side surfaces 204, 205 may be constructed to protrude outward, while as shown in c, d, and e of FIG. 12, the first and second side surfaces 204, 205 may be constructed to recess inward.

In order to further optimize the omni-directional wind load distribution of the base station antenna 200, for example, to reduce the lateral wind loads experienced by the base station antenna 200, the front surface 202 of the antenna housing 201 may have a recessed profile feature 301 located in the intermediate section (at least as a part of the intermediate section), as shown in FIG. 4 and FIG. 7.

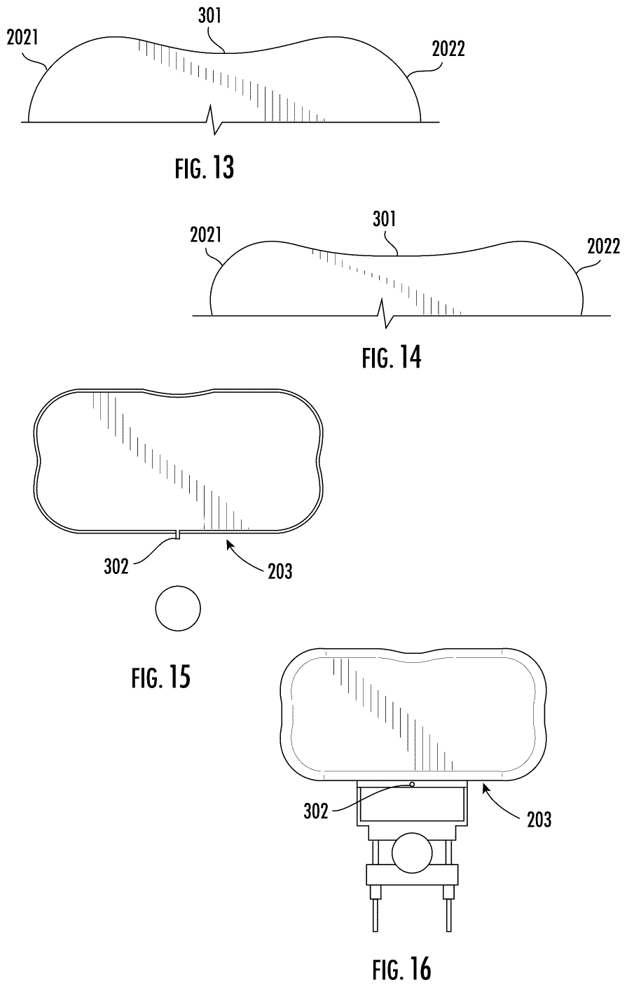

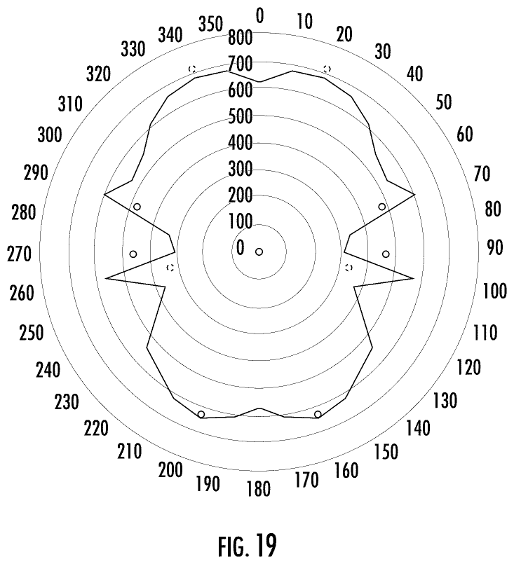

As shown in FIG. 13 and FIG. 14, two exemplary recessed profile features 301 on the front surface 202 of the antenna housing 201 are shown. It has been found that the recessed profile features 301 may advantageously reduce a peak of lateral wind loads applied in an orientated manner between 90° and 125°. As shown in FIG. 19, it can be seen from the omni-directional wind load distribution represented by the green line that one lateral wind load peak may be between 90° and 125° (e.g., near 100°). It has been found through the study that the lateral wind load peak is closely associated with the profile of the intermediate section of the front surface 202. By at least partially designing the intermediate section into the recessed profile feature 301, the above-described lateral wind load peak may be effectively reduced, which may be seen from local wind load points represented by green dots. The omni-directional wind load distribution may be further optimized by reducing the local wind load peak, such that some worst-case points are improved.

In some additional examples, the recessed profile feature 301 may transit directly to the first circular arc section 2021 on a first side and transit directly to the second circular arc section 2022 on a second side. Thus, the first circular arc section 2021, the recessed profile feature 301, and the second circular arc section 2022 form a consistent wave-shaped profile conducive to reducing the wind loads.

In some further examples, a space between the rearmost portion of the recessed profile feature 301 and the frontmost portion of the front surface 202 in the forward direction (shown with two dotted lines) may be between 10 mm and 30 mm, and FIG. 13 and FIG. 14 exemplarily show the radius of curvature of the recessed profile feature 301 and the spacing values above. In some improved examples, the recessed profile feature 301 extends longitudinally on 50% to 100% of a length of the antenna housing 201. It will be understood that the respective design parameters may be adjusted according to the actual application scene.

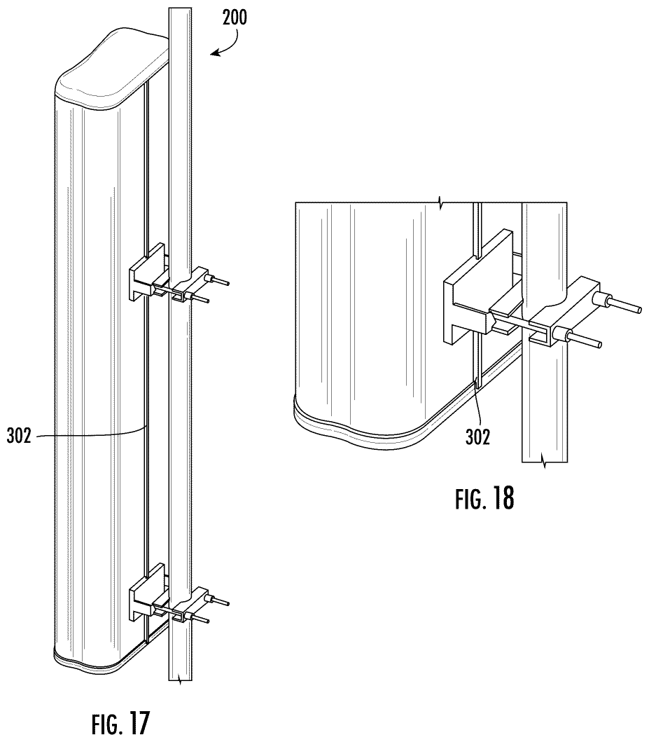

Additionally or alternatively, the rear surface 203 of the antenna housing 201 may have a rib profile feature 302 in an intermediate section (at least as a part of the intermediate section). As shown in FIG. 15 to FIG. 18, at least one rib profile feature 302 is integrally formed on the rear surface 203 of the antenna housing 201. It has been found through the study that the rib profile feature 302 may advantageously reduce a peak of lateral wind loads applied in an orientated manner between 45° and 85°. As shown in FIG. 19, it can be seen from the omni-directional wind load distribution represented by the green line that one lateral wind load peak may be between 45° and 85° (e.g., near 70°). It has been found through the study that the lateral wind load peak is closely associated with the profile of the intermediate section of the rear surface 203. By at least partially designing the intermediate section into the rib profile feature 302, the above-described lateral wind load peak may be effectively lowered, which may be seen from local wind load points represented by blue dots. The omni-directional wind load distribution may be further optimized by reducing the local wind load peak, such that some worst-case points are improved. The utilization of the interior cavity space may be advantageously improved by adopting the rib profile feature 302 on the rear surface 203 to avoid reducing the utilization of the interior cavity space due to excessive recessed profile features.

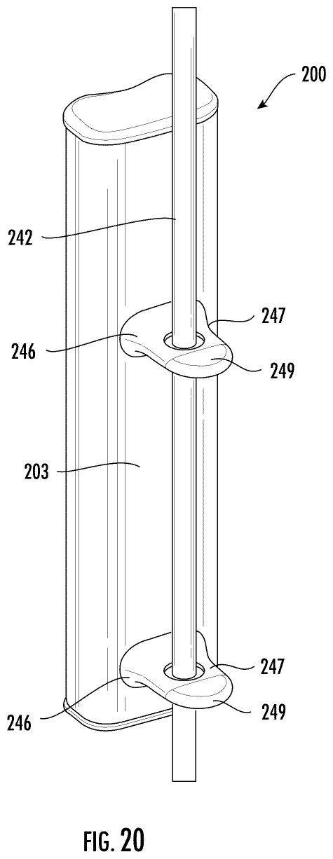

In some examples, the rib profile feature 302 may extend from the rear surface 203 rearward by 5 millimeters to 20 millimeters, and a width of the rib profile feature 302 is 2 millimeters to 10 millimeters. In some examples, the rib profile feature 302 extends longitudinally on 50% to 100% of a length of the antenna housing 201. In some examples, a plurality of rib profile features 302 may be integrally formed on the rear surface 203 of the antenna housing 201, and each rib profile feature 302 may be arranged in a mode of spacing apart from each other for a distance. In some examples, the rib profile feature 302 may be mounted to the rear surface 203 as a separate structure. It will be understood that the respective design parameters may be adjusted according to the actual application scene. With reference to FIG. 20 to FIG. 23, a base station antenna 200 for lowering wind loads according to another example of the present application is shown, wherein an mounting assembly for mounting the base station antenna 200 onto a holding pole 242 is shown. The mounting assembly may comprise a plate member 240 for mounting on the rear surface 203 of the antenna housing 201 and a bracket assembly 244 extending rearward from the plate member 240 and used for securing the holding pole 242. However, such mounting assembly has a significant impact on the wind load distribution of the base station antenna 200, particularly its rearward wind load distribution. To this end, the present application provides a base station antenna 200 for lowering wind loads, which provides the mounting assembly with a bracket cover 246 for covering the plate member 240 and the bracket assembly 244 externally, thereby further improving the wind load distribution, particularly rearward wind load distribution, of the base station antenna 200.

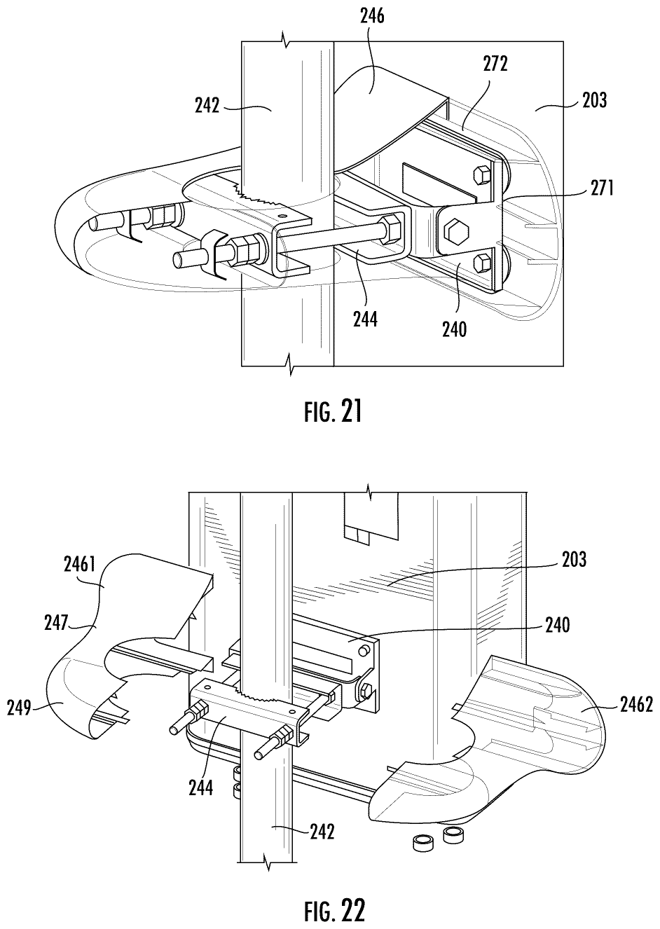

As shown in FIG. 20 and FIG. 21, the bracket cover 246 is constructed as a bracket cover 246 having a rounded and smooth profile. The rounded and smooth profile refers that the shape or edge of the bracket cover 246 is smooth and fluency without sharp corners or protrusions, and a soft and elegant visual feeling is capable of being provided. Advantageously, the side surfaces of the bracket cover 246 may have recessed profile features 247, thereby forming a profile structure that tapers rearward from the plate member 240. Additionally or alternatively, the rear surface 203 of the bracket cover 246 may have a circular arc profile feature 249. In the illustrated example, the rear surface 203 of the bracket cover 246 may have a substantially semi-circular circular arc profile feature 249. The wind load distribution, particularly rearward wind load distribution of the base station antenna 200 may further be improved by the recessed profile features 247 on the side surfaces and/or the circular arc profile feature 249 on the rear surface 203.

As shown in FIG. 22, the bracket cover 246 may comprise a first bracket cover half 2461 and a second bracket cover half 2462, and the first bracket cover half 2461 and the second bracket cover half 2462 may be assembled together to form the bracket cover 246. In some examples, the first bracket cover half 2461 and the second bracket cover half 2462 may be securely assembled together via one or more shape-fit structures. Further, the first bracket cover half 2461 and the second bracket cover half 2462 may be securely assembled onto the plate member 240 via one or more shape-fit structures, respectively.

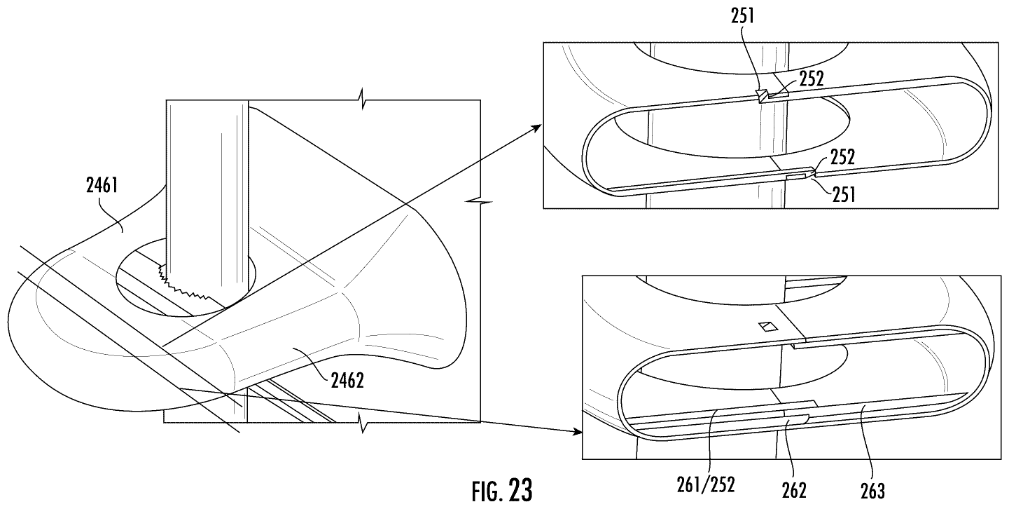

As shown in FIG. 23, two perspective views when the bracket cover 246 is cut apart along two sectioning lines are shown. The base station antenna 200 may comprise one or more first shape-fit structures, each first shape-fit structure may comprise a clamping slot 251 provided on one bracket cover half and a hook rib 252 provided on the other bracket cover half, and the hook rib 252 may be configured to be embedded within the clamping slot 251, thereby forming an efficient and reliable assembly between the two bracket cover 246 halves. Additionally or alternatively, the base station antenna 200 may comprise one or more second shape-fit structures, each second shape-fit structure may comprise a first rib 261 and a second rib 262 which are provided on one bracket cover half, extend horizontally and are spaced apart from each other, as well as a third rib 263 which is provided on the other bracket cover half and extends horizontally, and the third rib 263 is configured to be clamped between the first rib 261 and the second rib 262. The first rib 261 and the second rib 262 may extend beyond the first bracket cover half 2461 into the second bracket cover half 2462, and the third rib 263 may extend beyond the second bracket cover half 2462 into the first bracket cover half 2461. The first rib 261 and the second rib 262 may provide guide functions for the third rib 263 in one aspect and may provide clamping and securing effects for the third rib 263 in another aspect. Advantageously, the first rib 261 may be constructed as the hook rib 252 for being embedded into the clamping slot 251. Therefore, an efficient and secure connection between the two bracket cover 246 halves is further improved.

As shown in FIG. 21, the first bracket cover half 2461 and the second bracket cover half 2462 may be clamped on both sides of the horizontal direction of the plate member 240 by way of first shape-fit portions 271, respectively. Additionally or alternatively, the first bracket cover half 2461 and the second bracket cover half 2462 may be clamped on both sides of the vertical direction of the plate member 240 by way of second shape-fit portions 272, respectively. Therefore, a robust assembly of the bracket cover 246 on the plate member 240 of the base station antenna 200 is ensured. In some examples, the first shape-fit portions 271 may be constructed, for example, as step portions on the bracket cover 246 half and a side edge on the plate member 240. In some examples, the second shape-fit portions 272 may be constructed, for example, as clamping ribs on the bracket cover 246 half and clamping ribs on the plate member 240. It will be understood that the bracket cover 246 may also be assembled onto the antenna housing 201 by way of other feasible fastenings, for example, threaded connections, bonding, and the like, which will not be repeated here.

Although some specific examples of the present application have been described in detail through examples, those skilled in the art should understand that the above examples are only for illustration rather than for limiting the scope of the present application. Various examples disclosed herein can be combined arbitrarily without departing from the spirit and scope of the present disclosure. Those skilled in the art should also understand that various modifications may be made to the examples without departing from the scope and spirit of the present disclosure. The scope of the present application is defined by the attached claims.

What is claimed is:

1. A base station antenna for lowering wind loads, the base station antenna comprising:
an antenna housing having a front surface, a rear surface, a first side surface, and a second side surface;
a top end cover and a bottom end cover, the top end cover and the bottom end cover being arranged at an upper end and a lower end of the antenna housing to define an interior cavity;
and a radiating element located within the interior cavity and configured to transmit and receive radio frequency signals,
wherein the front surface has a recessed profile feature in an intermediate section, and the rear surface has a rib profile feature in the intermediate section.

2. The base station antenna of claim 1, wherein the recessed profile feature is configured to reduce a peak of lateral wind loads applied in an oriented manner between 90° and 125°, and the rib profile feature is configured to reduce a peak of lateral wind loads applied in an oriented manner between 45° and 85°.

3. The base station antenna of claim 2, wherein the antenna housing is integrally formed, and a dog bone-type cross-sectional profile is formed by the front surface, the rear surface, the first side surface, and the second side surface of the antenna housing, and the dog bone-type cross-sectional profile comprises:
a first circular arc section transiting to the first side surface from an intermediate section of the front surface in a forward protruding manner, and a second circular arc section transiting to the second side surface from the intermediate section of the front surface in a forward protruding manner; and/or
a third circular arc section transiting to the first side surface from an intermediate section of the rear surface in a rearward protruding manner, and a fourth circular arc section transiting to the second side surface from the intermediate section of the rear surface in a rearward protruding manner,
wherein a respective circular arc section corresponds to one circular trajectory having a particular radius of curvature, respectively.

4. The base station antenna of claim 3, wherein the base station antenna also comprises:
a frequency selection surface mounted in front of a radiating element, the frequency selection surface extending in a horizontal direction from a position next to the first circular arc section until a position next to the second circular arc section;
a first internal antenna component and a second internal antenna component, the first internal antenna component extending from a position next to the third circular arc section towards the first circular arc section and the second internal antenna component extending from a position next to the fourth circular arc section towards the second circular arc section, wherein the first internal antenna component and the second internal antenna component comprise at least one radiating element and a feed assembly for feeding the at least one radiating element, respectively.

5. The base station antenna of claim 3, wherein the first circular arc section and the second circular arc section which protrude forward and the third circular arc section and the fourth circular arc section which protrude rearward form four substantially symmetrical circular arc corners.

6. The base station antenna of claim 3, wherein the first circular arc section and the first side surface form a first consistent circular arc section and extend until the third circular arc section, and the second circular arc section and the second side surface form a second consistent circular arc section and extend until the third circular arc section, wherein a respective consistent circular arc section corresponds to one circular trajectory having a specific radius of curvature, respectively.

7. The base station antenna of claim 3, wherein the recessed profile feature transits directly to the first circular arc section at the first side and transits directly to the second circular arc section at the second side.

8. The base station antenna of claim 3, wherein a space between a rear most portion of the recessed profile feature to a frontmost portion of the front surface in a forward direction is between 10 mm and 30 mm.

9. The base station antenna of claim 1, wherein the rib profile feature extends from a rear surface rearward by 5 millimeters to 20 millimeters, and a width of the rib profile feature is 2 millimeters to 10 millimeters.

10. The base station antenna of claim 1, wherein the rib profile feature is integrally formed on the rear surface of the antenna housing.

11. The base station antenna of claim 1, wherein the recessed profile feature and the rib profile feature extend longitudinally on 50% to 100% of a length of the antenna housing.

12. The base station antenna of claim 1, wherein the base station antenna comprises an mounting assembly, the mounting assembly comprising:
a plate member for mounting on a rear surface of the antenna housing;
a bracket assembly extending rearward from a plate member and used for securing a holding pole;
a bracket cover for covering the plate member and the bracket assembly externally.

13. The base station antenna of claim 12, wherein a side surface of the bracket cover has a recessed profile feature, and a rear surface of the bracket cover has a circular arc profile feature.

14. A base station antenna for lowering wind loads, the base station antenna comprising:
an antenna housing having a front surface, a rear surface, a first side surface, and a second side surface;
a top end cover and a bottom end cover, the top end cover and the bottom end cover being arranged at an upper end and a lower end of the antenna housing to define an interior cavity;
and a radiating element located within the interior cavity and configured to transmit and receive radio frequency signals, wherein a dog bone-type cross-sectional profile is formed by the front surface, the rear surface, the first side surface, and the second side surface of the antenna housing, and the dog bone-type cross-sectional profile comprises:
a first circular arc section transiting to the first side surface from an intermediate section of the front surface in a forward protruding manner, and a second circular arc section transiting to the second side surface from the intermediate section of the front surface in a forward protruding manner; and
a third circular arc section transiting to the first side surface from an intermediate section of the rear surface in a rearward protruding manner, and a fourth circular arc section transiting to the second side surface from the intermediate section of the rear surface in a rearward protruding manner.

15. A base station antenna for lowering wind loads, the base station antenna comprising:
an antenna housing having a front surface, a rear surface, a first side surface, and a second side surface;
a top end cover and a bottom end cover, the top end cover and the bottom end cover being arranged at an upper end and a lower end of the antenna housing to define an interior cavity;
a radiating element located within the interior cavity and configured to transmit and receive radio frequency signals;
and a mounting assembly, the mounting assembly comprising: a plate member for being mounted on the rear surface of the antenna housing; a bracket assembly extending rearward from the plate member and used for securing a holding pole; and a bracket cover for covering the plate member and the bracket assembly externally, the bracket cover having a rounded and smooth profile.

16. The base station antenna of claim 15, wherein a rear surface of the bracket cover has a circular arc profile feature, and/or a side surface of the bracket cover has a recessed profile feature.

17. The base station antenna of claim 15, wherein the bracket cover comprises a first bracket cover half and a second bracket cover half, and the first bracket cover half and the second bracket cover half can be mounted together to form the bracket cover.

18. The base station antenna of claim 17, wherein the base station antenna comprises one or more first shape-fit structures, each first shape-fit structure comprises a clamping slot provided on one bracket cover half and a hook rib provided on the other bracket cover half, and the hook rib is configured to be embedded within the clamping slot.

19. The base station antenna of claim 17, wherein the base station antenna comprises one or more second shape-fit structures, each second shape-fit structure comprises a first rib and a second rib which are provided on one bracket cover half, extend horizontally and are spaced apart from each other for a distance, as well as a third rib which is provided on the other bracket cover half and extends horizontally, and the third rib is configured to be clamped between the first rib and the second rib.

20. The base station antenna of claim 17, wherein the first bracket cover half and the second bracket cover half are clamped on both sides of a horizontal direction of the plate member by way of first shape-fit portions, and the first bracket cover half and the second bracket cover half are clamped on both sides of a vertical direction of the plate member by way of second shape-fit portions, respectively.
